(19) United States
(12) Patent Application Publication
(10) Pub. No.: US 2008/0238821 A1
(43) Pub. Date: Oct. 2, 2008

(54) PLASMA DISPLAY PANEL

(76) Inventors: Motoyuki MIYATA, Hitachinaka (JP); Yuichi SAWAI, Miyazaki (JP); Hiroki YAMAMOTO, Hitachi (JP); Takashi NAITO, Funabashi (JP); Keiichi KANAZAWA, Ome (JP); Mitsuo HAYASHIBARA, Hitachinaka (JP); Fusao HOJO, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,652

(22) Filed: Jan. 25, 2008

(30) Foreign Application Priority Data
Mar. 30, 2007 (JP) 2007-090522

(51) Int. Cl. G09G 3/28

(52) U.S. Cl. 345/60

(57) ABSTRACT

To prevent sucking of a sealing material in steps of sealing and exhaust of a plasma display panel. The plasma display panel includes a front substrate and a rear substrate, in which the peripheries thereof are sealed by a glass sealing material. A sealing portion formed by the glass sealing material is formed of a multi-layered structure including at least two types of glass with different softening points. The entirety or part of the sealing portion on an inner side of the panel is formed of glass with the highest softening point. Since the high-temperature softened glass serves as a barrier for preventing sucking of the low-temperature softened glass into the panel, it is possible to prevent sucking of the sealing material into the panel. This can improve image display characteristics.

### FIELD OF THE INVENTION

The present invention relates to a plasma display panel.

### BACKGROUND OF THE INVENTION

Plasma display panels (hereinafter abbreviated as PDPs) have a configuration in which a front substrate having a display electrode formed thereon is opposed to a rear substrate having an address electrode formed thereon and the peripheries of the substrates are sealed by a sealing material. A plurality of spacers are provided between the front substrate and the rear substrate to hold the substrates with a predetermined interval between them. The space surrounded by the spacers, the front substrate, and the rear substrate is referred to as a cell in which a phosphor is fulled. A voltage is applied between the respective electrodes formed on the front substrate and the rear substrate. The resulting discharge between the electrodes produces ultraviolet rays which cause the phosphor to emit light, thereby displaying an image.

Lead-based glass has been conventionally used for the sealing material of PDPs. In recent years, however, there is a tendency to use lead-free glass, which contains no lead, in view of environmental issues. Patent Document 1 describes vanadium phosphate glass used as lead-free sealing glass which can contain a fire-resistant filler.

Patent Document 1: JP-A-2006-342044 (abst., claims)

### BRIEF SUMMARY OF THE INVENTION

In manufacture of a PDP, after the peripheries of a front substrate and a rear substrate are first sealed by a glass sealing material, the gas contained in the panel is exhausted and a rare gas such as neon and xenon is filled therein while the panel is heated. It has been shown that softened sealing glass may be sucked into the panel in the steps of panel sealing and exhaust of the PDP manufacture. The sealing material sucked into the panel adheres to the surface of a spacer or a phosphor to degrade image display characteristics.

The light emission efficiency of a PDP needs to be increased in order to improve the PDP image display characteristics. The efficiency of production of ultraviolet rays in discharge needs to be increased in order to enhance the PDP light emission efficiency. The ultraviolet-rays production efficiency is represented by a ratio of the valve as converted the amount of ultraviolet rays produced in discharge into the electric power to the valve of the electric power supplied to the PDP. To increase the ultraviolet-rays production efficiency, it is necessary to increase a pd product which is a product of a discharge gas pressure p and a distance d between discharge electrodes. The height of a spacer is desirably increased to meet that need.

As the height of a spacer is greater, the sealing portion is necessarily thicker. When the thickness of the sealing portion is increased, the softened sealing material is more readily sucked into the panel in the steps of panel sealing and exhaust.

It is an object of the present invention to provide a PDP in which a sealing material is not readily sucked into a panel in steps of sealing and exhaust of a panel.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows the configuration of a plasma display panel;

FIG. 2 is a schematic diagram showing an exemplary configuration of a sealing portion;

FIG. 3 is a schematic diagram showing another exemplary configuration of the sealing portion;

FIG. 4 is a schematic diagram showing yet another exemplary configuration of the sealing portion;

FIG. 5 is a schematic diagram showing another example of the sealing portion;

FIG. 6 is a schematic diagram showing a further example of the sealing portion; and

FIG. 7 is a schematic diagram showing a still further example of the sealing portion.

### DESCRIPTION OF REFERENCE NUMERALS

1 FRONT SUBSTRATE, 2 REAR SUBSTRATE, 3 DISPLAY ELECTRODE, 4 DATA ELECTRODE, 5 PHOSPHOR, 6 PHOSPHOR, 7 PHOSPHOR, 8 SPACER, 9 DIELECTRIC LAYER, 10 DIELECTRIC LAYER, 11 PROTECTING LAYER, 12 BLACK MATRIX, 13 SEALING MATERIAL, 14 HIGH-TEMPERATURE SOFTENED GLASS, 15 LOW-TEMPERATURE SOFTENED GLASS, 16 INTERMEDIATE LAYER, 17 ULTRAVIOLET RAYS

### DETAILED DESCRIPTION OF THE INVENTION

The present invention relates to provide a PDP in which a sealing portion on the peripheries of a front substrate and a rear substrate is formed of a multi-layered structure including at a plurality of types of glass with different softening points. The entirety or part of the sealing portion on an inner side of the panel is formed of glass with the highest softening point.

Specifically, the present invention relates to provide a PDP including a front substrate and a rear substrate which are provided opposite to each other, an electrode provided on the front substrate, an electrode provided on the rear substrate, a plurality of spacers placed between the front substrate and the rear substrate, and a phosphor put in space surrounded by the plurality of spacers. The peripheries of the front substrate and the rear substrate are sealed by a sealing material. A sealing portion sealed by the sealing material is formed of a multi-layered structure including a plurality of types of glass with different softening points. At least part of the sealing portion on an inner side of the panel is formed of glass with the highest softening point.

In the present invention, the glass with a higher softening point serves as a barrier for preventing sucking of the glass with a lower softening point. It is thus possible to prevent sucking of the sealing glass into the panel in steps of panel sealing and exhaust.

In the present invention, the sealing portion on the periphery of the panel is made of two types of glass with different softening points, but sufficient effects can be provided only by forming the sealing portion with two types of materials.

The methods for forming the sealing portion are not limited particularly. The sealing portion may be formed by temporarily bonding the glass with the higher softening point to one of the substrates, applying the glass with the lower softening point to the glass with the higher softening point, and then putting the other substrate on them and performing sealing, or by previously integrating the glass with the higher softening point and the glass with the lower softening point, putting it between the substrates, and performing sealing.

The sealing is performed at a sealing temperature of the glass with the lower softening point. To soften the glass with the higher softening point to some degree at the sealing temperature of the glass with the lower softening point to provide the glass with the higher softening point for adhesion, the difference in softening point between the glass with the higher softening point and the glass with the lower softening point is desirably 60° C. or less, and more particularly, 30 to 60° C. With such a temperature difference, the glass with the higher softening point is softened to some degree, so that the sealing structure can be formed more robustly.

In the present invention, the entirety or part of the sealing portion on the inner side of the panel is formed of the glass with the higher softening point. This provides the effect of preventing sucking of the glass with the lower softening point for the glass with the higher softening point. Most preferably, the entirety of the sealing portion on the inner side of the panel is formed of the glass with the higher softening point, and the glass with the lower softening point is formed on the outer side of the panel.

The glass with the higher softening point and the glass with the lower softening point are preferably arranged such that the interface between them is inclined to the front substrate and the rear substrate. This arrangement can increase the area of the glass with the lower softening point in contact with the front substrate and the rear substrate to more tightly bond the sealing portion. All or some of the plurality of types of glasses forming the sealing portion preferably contain a filler. The addition of the filler can improve durability of the glass and adjust the coefficient of thermal expansion.

It is extremely preferable that the plurality of types of glasses forming the sealing portion are made of the same glass base. When they are made of the same glass base, the heating of them during sealing results in an intermediate layer in which the glass components of them are diffused at the interface between those types of glass. This can integrate those types of glass to form the sealing portion more strongly. The intermediate layer desirably has a width of 5 μm or more in order to allow the intermediate layer to provide the effect of integrating the types of glass sufficiently.

It is significantly preferable that each of the plurality of types of glass forming the sealing portion is made of vanadium phosphate glass. The softening point of vanadium phosphate glass is lower than that of Bi-based glass, for example, and is close to that of lead-based glass. For many PDPs, material selection and manufacture condition setting have been made to adapt to the use of lead-based glass. The use of vanadium phosphate glass allows manufacture of PDPs without greatly changing materials or manufacture conditions.

Vanadium phosphate glass preferably contains V₂O₅, P₂O₅, Sb₂O₃, and BaO. V₂O₅ and P₂0₅ are glass-forming oxides and form glass when the weight ratio of V₂O₅/P₂O₅ ranges from 0.5 to 3.2. BaO has the effect of stabilizing glass. Sb₂O₃ has the effect of increasing the durability of glass.

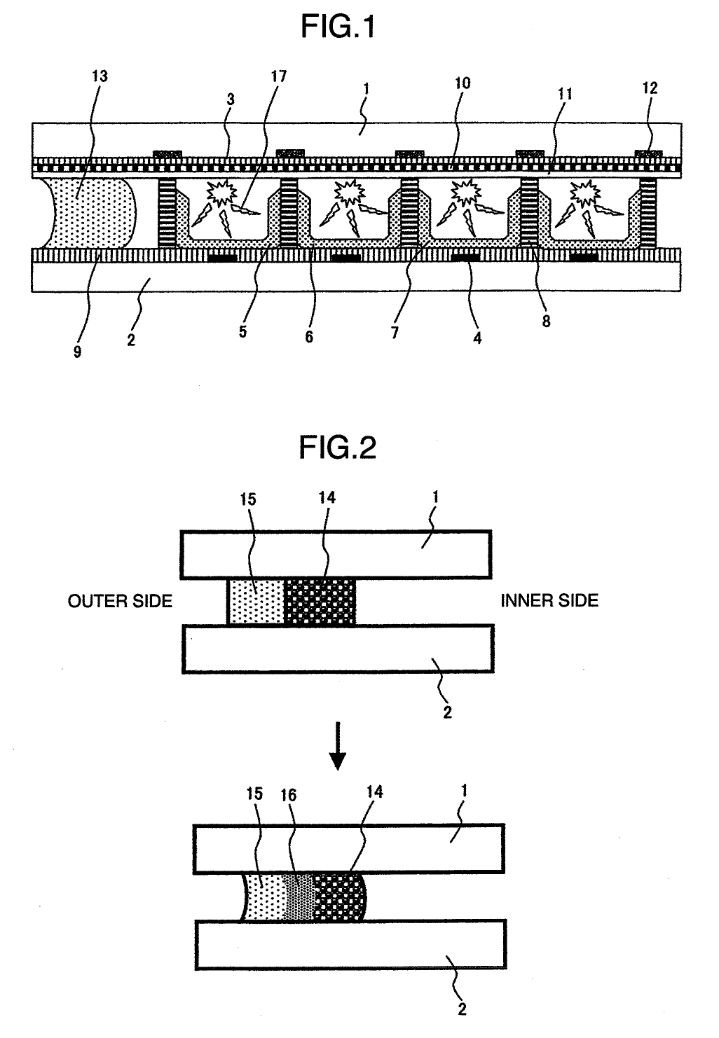

FIG. 1 schematically shows the configuration of a PDP. The PDP is a display device in which discharge is produced in very small space filled with a rare gas such as neon and xenon to cause a phosphor put therein to emit light.

In the PDP, a front substrate 1 and a rear substrate 2 are typically opposed with an interval of approximately 100 to 200 μm between them. The interval between the substrates is held by spacers 8. The peripheries of the substrates are sealed by a sealing material 13 mainly made of glass, and a rare gas is filled thereinto. A very small space defined by the substrates and the spacers 8 is referred to as a cell. Phosphors 5, 6, and 7 of three colors of red, green, and blue (hereinafter referred to as R, G, and B) are individually put into the cells. The cells for the three colors constitute one pixel to emit light in the respective colors.

Each of the substrates has a regularly arranged electrode formed thereon. A voltage of 100 to 200 volts is selectively applied between the paired electrodes on the front substrate and rear substrate in accordance with a display signal. The resulting discharge between the electrodes produces ultraviolet rays which in turn cause the phosphor to emit light, thereby displaying image information.

On the side of the rear substrate of the PDP, a data electrode (also referred to as an address electrode) 4 is formed on the substrate. The data electrode is made of Cr/Cu/Cr wire or silver wire, for example. The electrode is formed with a printing technique or a sputtering technique.

Address discharge is performed between an address electrode and a display electrode of a cell which is to be lit, so that wall charge is accumulated in the cell. Next, a predetermined voltage is applied between paired display electrodes to cause display discharge only in the cell having the wall charge accumulated through the address discharge, resulting in production of ultraviolet rays 17. In this manner, the plasma display performs display.

A dielectric layer 9 is formed over the data electrode 4. The dielectric layer 9 is provided for controlling electric current of the address electrode and for protecting the address electrode against breakdown. The spacer 8 in a strip shape or a grid shape having openings is formed on the dielectric layer 9. The spacers are arranged in a linear form (stripe form or rib form) or a grid form. The spacers 8 are formed by applying glass paste with a printing technique or by shaving a thick film with a sandblast technique, for example. The phosphors of the respective colors are applied to the wall surfaces of the cells defined by the spacers 8.

A display electrode 3 is formed on the front substrate 1. The display electrode 3 is formed of a transparent electrode and a bus electrode. The transparent electrode is made of film of indium-tin oxide (ITO film) or the like, while the bus electrode is made of Cr/Cu/Cr wire or silver wire, for example. The display electrode 3 is disposed perpendicularly to the data electrode formed on the rear substrate. A dielectric layer 10 formed over the display electrode 3 protects the electrode and has a memory function of forming wall charge in discharge. A protecting layer 11 is formed over the dielectric layer 10 for protecting the electrode and the like from plasma and is generally formed of MgO film. A black matrix 12 (black-color layer) having an opening corresponding to each pixel is formed on the side of the front substrate 1. This is because the black color is seen from the side of the front substrate to advantageously improve contrast of images. The black matrix 12 may be formed above or below the display electrode.

The rear substrate 2 and the front substrate 1 are opposed with precise alignment and the peripheries thereof are sealed. The sealing material 13 is made of a plurality of glass sealing materials having different softening points. While the PDP is heated, the gas contained therein is exhausted and a rare gas is filled therein.

A voltage is applied to a point where the data electrode 4 intersects the display electrode 3 to cause discharge in the rare gas to change the gas into plasma. The ultraviolet rays 17 produced when the rare gas returns from the plasma to the original state are used to cause the phosphor to emit light.

The sealing glass preferably has a density of 2 to 5 g/cm³. The use of glass with such a small density can reduce the weight of the PDP. Preferable glass types achieving the glass density include vanadium phosphate glass which contains no PbO and contains at least V₂O₅, P₂O₅, Sb₂O₃, and BaO.

In vanadium phosphate glass, high-temperature softened glass preferably contains 45 to 55% of V₂O₃, 22 to 30% of P₂O₅₁ 5 to 30% of Sb₂O₃, and 2 to 25% of BaO by weight in terms of oxide. Low-temperature softened glass preferably contains 50 to 65% of V₂O₃, 20 to 25% of P₂O₅, 5 to 30% of Sb₂O₃, and 2 to 25% of BaO by weight in terms of oxide.

Vanadium phosphate glass is made of glass-forming oxides V₂O₅ and P₂O₅ and serves as glass when the weight ratio of V₂O₅/P₂O₅ approximately ranges from 0.5 to 3.2. Vanadium phosphate glass has a lower glass softening point as the weight ratio of V₂O₅/P₂O₅ is larger, that is, as the ratio of V₂O₅ to P₂O₅ is larger. To provide vanadium phosphate glass with a softening point of 420 to 450° C., it is preferable that it contains 45 to 55% of V₂O₅ and 22 to 30% of P₂O₅, and the weight ratio of V₂O₅/P₂O₅ ranges from 1.5 to 2.5. To provide vanadium phosphate glass with a softening point of 390 to 420° C., it is preferable that it contains 50 to 65% of V₂O₅ and 20 to 25% of P₂O₅, and the weight ratio of V₂O₅/P₂O₅ ranges from 2.0 to 3.2.

BaO has the effect of stabilizing vanadium phosphate glass, so that it is an essential component and is contained by 2 to 25 wt %. Sb₂O₃ has the effect of increasing water resistance of glass and thus is an essential component and is contained by 5 to 30 wt %.

In addition, TeO₂ is not an essential component but is desirably contained as appropriate since it has the effect of reducing the glass softening point. R₂O (R represents alkali metal) is not an essential component but is desirably contained as appropriate since the addition of R₂O can increase electric resistivity.

The sealing portion on the peripheries of the substrates is formed of at least two types of glass having different softening points and the sealing is performed at the sealing temperature of the glass having the lowest softening point to allow a reduction in sealing temperature. Especially, it is possible to use glass including high-temperature softened glass with a softening point of 420 to 450° C. and low-temperature softened glass with a softening point of 390 to 420° C. Those softening points are lower than that of conventional lead-free glass such as Bi-based glass and are close to that of lead-based glass. The use of the glass can improve image display characteristics since it reduces production of impurity gas such as carbon dioxide which would be produced from the sealing material during sealing to deteriorate the protecting film or the phosphor.

Vanadium phosphate glass can be formed to include the high-temperature softened glass and the low-temperature softened glass having the softening points slightly differing by 30 to 60° C., so that the high-temperature softened glass is softened to some degree during sealing to provide the sealing effect. Thus, the sealing portion can be formed more strongly.

A filler can be added to the sealing glass. The filler preferably has a density equivalent to that of the glass. Since the sealing glass desirably has a density of 2 to 5 g/cm³, the filler preferably has a density of 2 to 5 g/cm³. The density of the filler matched to the density of the glass can prevent the filler from sinking or floating in the glass to disperse the filler uniformly in the glass.

The filler is preferably made of SiO₂, Al₂O₃, TiO₂ or a multiple oxide such as aluminum acid titanium alone or in combination by mixing some of them. SiO₂, Al₂O₃, TiO₂ and a multiple oxide thereof have excellent wettability with vanadium phosphate glass and can form a tight sealing material.

The glass preferably contains 0 to 60% of the filler by volume. When it contains more than 60% of the filler by volume, a tight sealing material cannot be provided. The filler preferably has an average particle diameter of 1 to 40 μm. If it is less than 1 μm, the filler floats to prevent uniform dispersion when the filler is mixed in the glass. If it is larger than 40 μm, the filler sinks to prevent uniform dispersion when the filler is mixed in the glass.

The thickness of the sealing material is not limited in the present invention and is determined by design conditions defining the interval between the front substrate and rear substrate. The sealing material preferably has a thickness of 100 to 500 μm and a width of 3 to 10 mm in the PDP of the present invention. The lower value of the thickness of the sealing material is set to prevent a reduction in discharge efficiency, while the upper value is set to provide sufficient sealing strength. A width of the sealing material smaller than 3 mm cannot provide sufficient sealing strength. A width of the sealing material larger than 10 mm results in an increased cost of the sealing material, a smaller area for image display, and an increased weight.

When the sealing material is made of a plurality of materials of the same glass base, an intermediate layer is produced at the interface between them where the glass components and filler are continuously changed. The intermediate layer preferably has a width of 5 μm or larger to provide a tightly integrated sealing material.

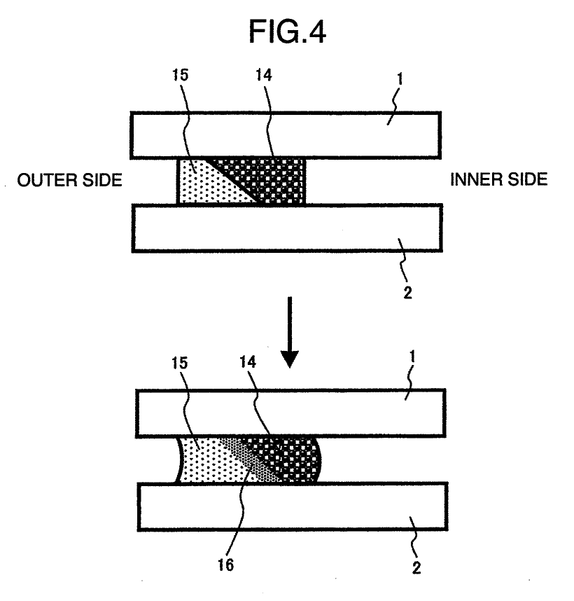

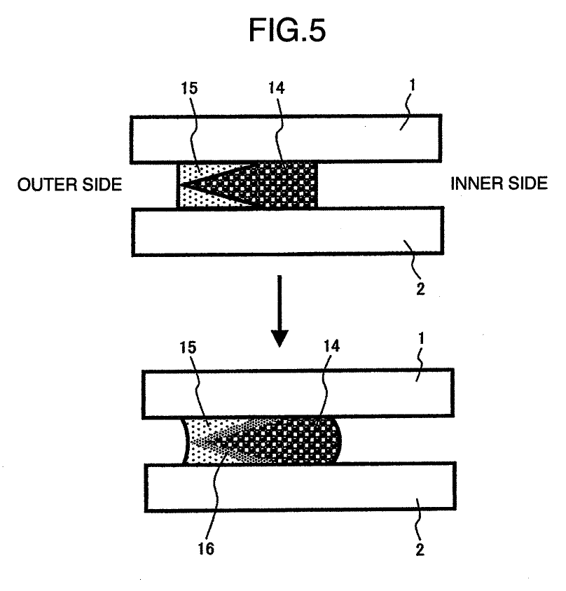

FIGS. 2 to 7 are schematic diagrams showing the sealing portion when two types of glass are used.

FIG. 2 shows schematic diagrams in which a high-temperature softened glass 14 and a low-temperature softened glass 15 are disposed such that the interface between them is perpendicular to the front substrate 1 and the rear substrate 2 before sealing. FIG. 2(a) is a schematic diagram before the sealing, while FIG. 2(b) is a schematic diagram after the sealing. When the high-temperature softened glass and the low-temperature softened glass are made of the same glass base, an intermediate glass 16 is formed at the interface due to dispersion of the glass components.

In the configuration of FIG. 2, the high-temperature softened glass 14 is placed closer to a light-emitting area in which a spacer is formed (hereinafter referred to as an inner side) to allow prevention of sucking of the low-temperature softened glass 15 disposed on an outer side. If the low-temperature softened glass is placed on the inner side, the sucking cannot be prevented.

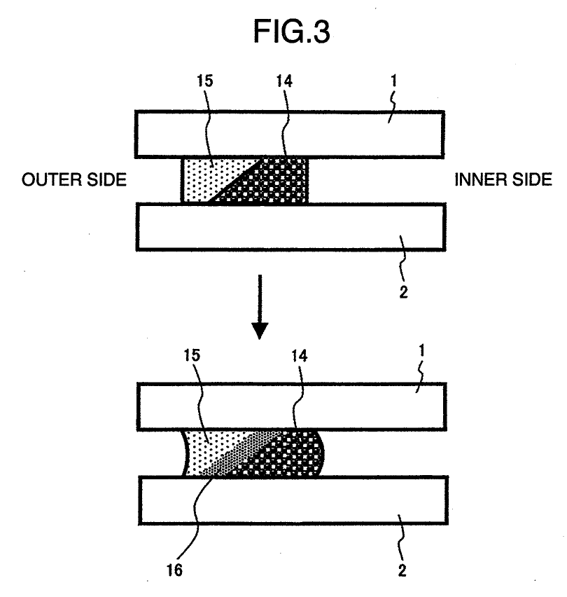

FIGS. 3 to 5 show cases where the interface between the high-temperature softened glass 14 and the low-temperature softened glass 15 is at an arbitrary angle with respect to the front substrate and the rear substrate before sealing. FIGS. 3(a), 4(a), and 5(a) are schematic diagrams before sealing, while FIGS. 3(b), 4(b), and 5(b) are schematic diagrams after the sealing. In FIGS. 3 to 5, the high-temperature softened glass 14 placed on the inner side can prevent the low-temperature softened glass 15 placed on the outer side from being sucked into the panel. In FIGS. 3 to 5, the area of the low-temperature softened glass in contact with the front substrate and the rear substrate is larger than in the case of FIG. 2, so that the sealing portion can be more tightly bonded.

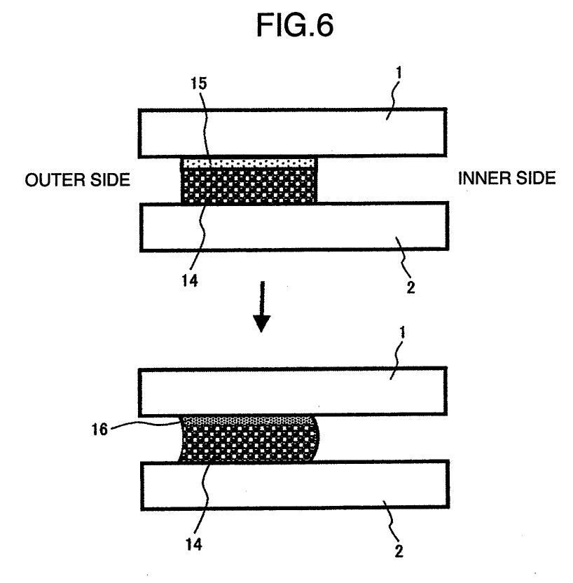

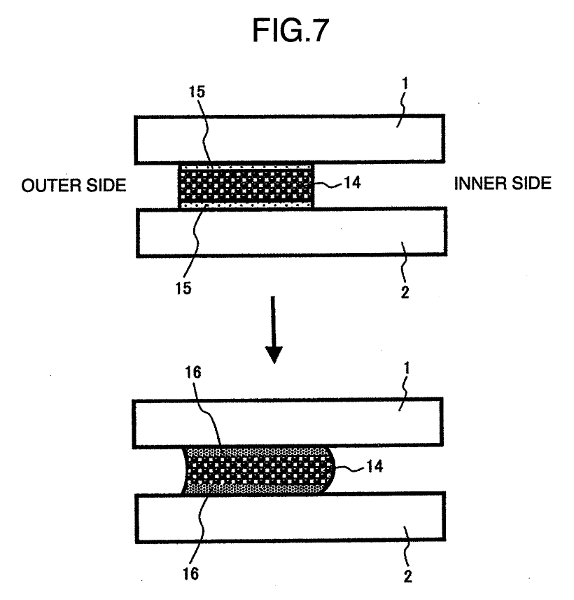

FIGS. 6 and 7 show cases where the interface between two types of glass is in parallel with the front substrate and the rear substrate. FIGS. 6(a) and 7(a) are schematic diagrams before sealing, while FIGS. 6(b) and 7(b) are schematic diagrams after the sealing. Since the high-temperature softened glass and the low-temperature softened glass are placed one on another, the amount of the low-temperature softened glass can be reduced to minimize sucking of the low-temperature softened glass. When the same glass base is used, an intermediate layer is formed at the interface where the glass components and filler are continuously changed, so that the sucking can be more effectively prevented.

When the high-temperature softened glass and the low-temperature softened glass are placed in parallel as shown in FIGS. 6 and 7, the high-temperature softened glass desirably occupies 80% or more of the thickness of the sealing portion. In this case, if the same glass base is used, the intermediate layer formed during the sealing further reduces the thickness of the low-temperature softened glass, and in some cases, the entire low-temperature softened glass is changed into the intermediate layer due to the dispersion of the high-temperature softened glass component. This can make it more difficult to suck the low-temperature softened glass.

The sealing material can be formed by subsequently applying the high-temperature softened glass and the low-temperature softened glass and heating them, or by previously forming a bulk of the high-temperature softened glass, locating it, applying the low-temperature softened glass on the surface of the bulk, and heating them for sealing. Alternatively, the sealing material can be provided by forming a layer of the low-temperature softened glass on the surface of a bulk of the high-temperature softened glass to form an integrated sealing material and then locating and heating it.

The sealing technique of the present invention is not limited to application to PDPs but is applicable to any device as long as it includes a light-emitting source or the like between two opposite substrates and requires a sealing step. Examples of devices to which the present invention is applicable include a liquid crystal display panel and a field emission type display panel.

Next, examples will be described specifically.

### EXAMPLE 1

A front substrate and a rear substrate, on which electrodes, protecting layers, spacers, and phosphors were formed, were sealed by using two types of glass shown in Table 1. In Table 1, A represents low-temperature softened glass and B represents high-temperature softened glass. Each glass was coarsely ground in a mortar and then finely ground with a ball mill into glass powder having an average particle diameter of 10 μm. The average particle diameter was measured by a particle size distribution analyzer SALD-2000 (manufactured by Simadzu Corporation.) of a laser optical type.

Table 2 shows fillers used in Example 1. Similarly to glass frit, the fillers were ground with a mortar and a ball mil into filler powder having an average particle diameter of 10 μm.

The glass powder shown in Table 1 and the filler powder shown in Table 2 were introduced into a vehicle (containing 15 mass % of ethyl cellulose) provided by solving ethyl cellulose in an organic solvent (butyl carbitol) and mixed in a mortar, and then kneaded in a three-roll mill to prepare glass paste.

Then, the prepared glass paste was used to form a sealing material as follows, and sealing was performed.

First, the high-temperature softened glass paste was applied to the outer periphery of the rear substrate with a dispenser. After the application, it was left standing for ten minutes at room temperature for leveling of the paste coating. Then, it was heated at 150° C. for ten minutes to volatilize the organic solvent in the paste coating to some degree. Next, the temperature was increased at a rise rate of 10° C./min and calcination was performed at 460° C.

Next, the low-temperature softened glass paste was applied to the outside of the high-temperature softened glass paste with a dispenser. After the application, it was left standing for ten minutes at room temperature for leveling of the paste coating. Then, it was heated at 150° C. for ten minutes to volatilize the organic solvent in the paste coating to some degree. Next, the front substrate and the rear substrate were aligned and fixed with a clip. The temperature was increased at a rise rate of 10° C./min and sealing was performed at 420° C.

As described above, 20 panels of 32 inches were formed. The sealing portion had a height of 300 μm and a width of 10 mm.

For the formed panels, the yield was determined in terms of leakage during evacuation, and the sucking amount (deformation amount) of the sealing material was measured. A yield less than 100% was determined to be unacceptable as a panel product.

Table 3 shows the configurations of the sealing material and the evaluation results. No. 1 to No. 6 show cases where single glass was used for sealing. No. 7 to No. 18 shows cases where two types of glass were used for sealing. Nos. 7, 11, and 15 show cases where a bulk of high-temperature softened glass was previously formed and then low-temperature softened glass was applied on the surface thereof and sealing was performed.

As a result, when the sealing material was formed of only one type of glass as shown in No. 1 to No. 6, the leakage yield was low and hermeticity was insufficient. When two types of glass were used as shown in No. 7 to No. 18, the resulting panel had sufficient hermeticity.

TABLE 1
composition of glass

| glass No. | V₂O₅ | P₂O₅ | Sb₂O₃ | BaO | softening point (° C.) |
|---|---|---|---|---|---|
| A | 57 | 20 | 20 | 3 | 396 |
| B | 48 | 25 | 5 | 22 | 445 |

TABLE 2
type of filler

| No. | name | density |
|---|---|---|
| S | silica | 2.2 |
| K | cordierite | 2.5 |
| A | alumina | 4.0 |

TABLE 3
sealing material and sealing results

| | low-temperature | | | high-temperature | | | | | |
|---|---|---|---|---|---|---|---|---|---|
| | softened glass | | | softened glass | | | | | |
| | | filler | | | filler | | sealing | sealing evaluation | |
| | glass | | quantity | glass | | quantity | temperature | leakage | average of sucking |
| No. | No. | No. | (vol %) | No. | No. | (vol %) | (° C.) | yield | amount (μm) |
| 1 | A | S | 35 | — | — | — | 420 | 30 | 7600 |
| 2 | A | K | 35 | — | — | — | 420 | 20 | 8400 |
| 3 | A | A | 35 | — | — | — | 420 | 10 | 10800 |
| 4 | — | — | — | B | S | 40 | 460 | 60 | 5900 |
| 5 | — | — | — | B | K | 40 | 460 | 35 | 6700 |
| 6 | — | — | — | B | A | 40 | 460 | 15 | 7600 |
| 7 | A | S | 35 | B | — | — | 420 | 100 | 3 |
| 8 | A | S | 35 | B | S | 40 | 420 | 100 | 50 |
| 9 | A | S | 35 | B | K | 40 | 420 | 100 | 130 |
| 10 | A | S | 35 | B | A | 40 | 420 | 100 | 220 |
| 11 | A | K | 35 | B | — | — | 420 | 100 | 5 |
| 12 | A | K | 35 | B | S | 40 | 420 | 100 | 270 |
| 13 | A | K | 35 | B | K | 40 | 420 | 100 | 180 |
| 14 | A | K | 35 | B | A | 40 | 420 | 100 | 170 |
| 15 | A | A | 35 | B | — | — | 420 | 100 | 7 |
| 16 | A | A | 35 | B | S | 40 | 420 | 100 | 480 |
| 17 | A | A | 35 | B | K | 40 | 420 | 100 | 310 |
| 18 | A | A | 35 | B | A | 40 | 420 | 100 | 290 |

### EXAMPLE 2

Panels were formed in a similar manner to that in Example 1 except that the filler amount and filler average particle diameter were changed. Table 4 shows the relationship between the filler amount, the average particle diameter, and the presence or absence of leakage. The sealing method of panels and the number of formed panels were identical to those in Example 1. For the presence or absence of leakage, “X” is shown when leakage was found in any one of the panels, and “O” is shown when leakage was not found at all.

As a result, favorable panels with no leakage were provided when the filler average particle diameter ranged from 1 to 40 μm and the filler amount was equal to or less than 60% by volume.

TABLE 4
filler amount, average particle diameter, and sealing results

| | low-temperature | | | | high-temperature | | | | | |
|---|---|---|---|---|---|---|---|---|---|---|
| | softened glass | | | | softened glass | | | | | |
| | | filler | | | | filler | | | | |
| | | | | average | | | | average | | |
| | | | | particle | | | | particle | sealing | |
| | glass | | quantity | diameter | glass | | quantity | diameter | temperature | leak |
| No. | No. | No. | (vol %) | (μm) | No. | No. | (vol %) | (μm) | (° C.) | yield |
| 19 | A | S | 35 | 10 | B | S | 35 | 0.8 | 420 | X |
| 20 | A | S | 35 | 10 | B | S | 35 | 2.8 | 420 | ◯ |
| 21 | A | S | 35 | 10 | B | S | 35 | 6.8 | 420 | ◯ |
| 22 | A | S | 35 | 10 | B | S | 35 | 14 | 420 | ◯ |
| 23 | A | 5 | 35 | 10 | B | S | 35 | 26 | 420 | ◯ |
| 24 | A | S | 35 | 10 | B | S | 35 | 40 | 420 | ◯ |
| 25 | A | S | 35 | 10 | B | S | 35 | 41 | 420 | X |
| 26 | A | A | 30 | 0.5 | B | A | 40 | 23 | 420 | ◯ |
| 27 | A | A | 30 | 3.7 | B | A | 40 | 23 | 420 | ◯ |
| 28 | A | A | 30 | 8.4 | B | A | 40 | 23 | 420 | ◯ |
| 29 | A | A | 30 | 22 | B | A | 40 | 23 | 420 | ◯ |
| 30 | A | A | 30 | 40 | B | A | 40 | 23 | 420 | ◯ |
| 31 | A | A | 30 | 41 | B | A | 40 | 23 | 420 | X |
| 32 | A | S | 35 | 15 | B | — | 0 | — | 420 | ◯ |
| 33 | A | S | 35 | 15 | B | K | 10 | 16 | 420 | ◯ |
| 34 | A | S | 35 | 15 | B | A | 30 | 16 | 420 | ◯ |
| 35 | A | S | 35 | 15 | B | S | 45 | 16 | 420 | ◯ |
| 36 | A | S | 35 | 15 | B | K | 60 | 16 | 420 | ◯ |
| 37 | A | S | 35 | 15 | B | A | 61 | 16 | 420 | X |
| 38 | A | — | 0 | — | B | K | 30 | 13 | 420 | ◯ |
| 39 | A | K | 15 | 23 | B | K | 30 | 13 | 420 | ◯ |
| 40 | A | K | 40 | 23 | B | K | 30 | 13 | 420 | ◯ |
| 41 | A | K | 60 | 23 | B | K | 30 | 13 | 420 | ◯ |
| 42 | A | K | 61 | 23 | B | K | 30 | 13 | 420 | X |

It should be further understood by those skilled in the art that although the foregoing description has been made on embodiments of the invention, the invention is not limited thereto and various changes and modifications may be made without departing from the spirit of the invention and the scope of the appended claims.

1. A plasma display panel comprising:
a front substrate and a rear substrate which are provided opposite to each other;
an electrode provided on the front substrate;
an electrode provided on the rear substrate;
a plurality of spacers placed between the front substrate and the rear substrate; and
a phosphor put in space surrounded by the plurality of spacers,
wherein peripheries of the front substrate and the rear substrate are sealed by a sealing material,
a sealing portion sealed by the sealing material is formed of a multi-layered structure including a plurality of types of glass with different softening points, and
at least part of the sealing portion on an inner side of the panel is formed of glass with the highest softening point.

2. The plasma display panel according to claim 1, wherein the sealing portion is sealed at a sealing temperature of glass with the lowest softening point.

3. The plasma display panel according to claim 1, wherein glass with a higher softening point of the two types of glass with different softening points is provided on the inner side of the panel and glass with a lower softening point is provided on the outer side of the panel.

4. The plasma display panel according to claim 3, wherein an interface between the glass with the higher softening point and the glass with the lower softening point is perpendicular or nearly perpendicular to the front substrate and the rear substrate.

5. The plasma display panel according to claim 3, wherein an interface between the glass with the higher softening point and the glass with the lower softening point is inclined to the front substrate and the rear substrate.

6. The plasma display panel according to claim 1, wherein one of the two types of glass with different softening points is provided closer to the front substrate and the other glass is provided closer to the rear substrate.

7. The plasma display panel according to claim 1, wherein at least one of the plurality of types of glasses with different softening points contains a filler.

8. The plasma display panel according to claim 1, wherein the two types of glass with different softening points are formed of the same glass base.

9. The plasma display panel according to claim 1, wherein the two types of glass with different softening points are formed of the same glass base, further comprising an intermediate layer formed at an interface between the two types of glass by dispersion of glass components of the two types of glass.

10. The plasma display panel according to claim 1, wherein each of the two types of glass with different softening points is made of vanadium phosphate glass.

11. The plasma display panel according to claim 10, wherein one of the two types of glass is made of vanadium phosphate glass with a softening point of 420 to 450° C. and the other glass is made of vanadium phosphate glass with a softening point of 390 to 420° C.

12. The plasma display panel according to claim 10, wherein each of the two types of vanadium phosphate glass is made of vanadium phosphate glass containing V₂O₅, P₂O₅, Sb₂O₃, and BaO.

13. The plasma display panel according to claim 10, wherein one of the two types of vanadium phosphate glass contains 45 to 55% of V₂O₃, 22 to 30% of P₂O₅, 5 to 30% of Sb₂O₃, and 5 to 30% of BaO by weight in terms of oxide, and the other contains 50 to 65% of V₂O₃, 20 to 25% of P₂O₅, 5 to 30% of Sb₂O₃, and 2 to 25% of BaO by weight in terms of oxide.

14. The plasma display panel according to claim 12, wherein each of the two types of vanadium phosphate glass contains a filler.

15. The plasma display panel according to claim 14, wherein the filler is formed of at least one selected from SiO₂, Al₂O₃, TiO₂ or a multiple oxide thereof.

16. The plasma display panel according to claim 14, wherein each of the types of glass contains 0 to 60% of the filler by volume.

17. The plasma display panel according to claim 14, wherein the filler has an average particle diameter of 1 to 40 μm.

18. The plasma display panel according to claim 1, wherein each of the types of glass forming the sealing portion has a density of 2 to 5 g/cm³.

19. The plasma display panel according to claim 1, wherein each of the types of glass forming the sealing portion has a density of 2 to 5 g/cm³₁ and the glass contains a filler having a density of 2 to 5 g/cm³.

20. The plasma display panel according to claim 9, wherein the intermediate layer has a width of at least 5 μm.
